(19) United States
(12) Patent Application Publication
(10) Pub. No.: US 2021/0012305 A1
(43) Pub. Date: Jan. 14, 2021

(54) SETTLEMENT SYSTEM, SETTLEMENT METHOD, AND NON-TRANSITORY STORAGE MEDIUM

(71) Applicant: NEC Corporation, Minato-ku, Tokyo (JP)

(72) Inventors: Tsugunori TAKATA, Tokyo (JP); Hideo YOKOI, Tokyo (JP); Kota IWAMOTO, Tokyo (JP); Soma SHIRAISHI, Tokyo (JP)

(73) Assignee: NEC Corporation, Minato-ku, Tokyo (JP)

(21) Appl. No.: 16/978,297

(22) PCT Filed: Oct. 10, 2018
(86) PCT No.: PCT/JP2018/037688

§ 371 Date: Sep. 4, 2020

(30) Foreign Application Priority Data
Mar. 19, 2018 (JP) 2018-050585

(51) Int. Cl. G06Q 20/20; G07G 1/12; G06K 9/20

(52) U.S. Cl. CPC G06Q 20/201; G06K 9/2054; G06Q 20/208; G07G 1/12

(57) ABSTRACT

There is provided a settlement system (10) including an acquisition unit (11) that acquires an image including a product, generated by an imaging unit, an image analysis unit (12) that recognizes a product and a first pattern or a second pattern attached to the product, and a registration unit (13) that registers the product without changing a price of the product in a case where the first pattern is recognized, and registers the product by changing the price of the product in a case where the second pattern is recognized.

### TECHNICAL FIELD

The present invention relates to a settlement system, a settlement method, and a program.

### BACKGROUND ART

There is a discount sale of a product that meets a predetermined condition such as an impending expiration date or an impending best-by date. Further, as an example of the practice, a method for attaching a discount label or the like to a product to be discounted to clearly indicate to a customer or a store worker (for example, an operator of a register) that the product is to be discounted has been used. In addition, in recent years, a technique of recognizing a product by image analysis and registering the product as a checkout target has been studied. Further, a technique of recognizing a discount label or the like attached to a product to be discounted by image analysis has also been studied. Related techniques are disclosed in Patent Documents 1 to 3.

Patent Document 1 discloses a technique of recognizing additional information such as a discount label attached to a product by image analysis and reflecting the result in a checkout process.

Patent Document 2 discloses a technique of registering in advance whether or not a product is a service label target product, and performing a control so that the service label is recognized in a case where the product is the service label target product, and displaying a message such as “Is there a discount label?” to a display for a store clerk in a case where the service label cannot be recognized from the service label target product.

Patent Document 3 discloses a technique of recognizing a position of a human hand or a position of tongs to register sales-related information such as an age, a sex, and a discount rate in association.

### RELATED DOCUMENT

### Patent Document

[Patent Document 1] Japanese Patent Application Publication No. 2017-41271

[Patent Document 2] Japanese Patent Application Publication No. 2015-207313

[Patent Document 3] Japanese Patent Application Publication No. 2016-110480

### SUMMARY OF THE INVENTION

### Technical Problem

A store that performs discount sales wants a way to reliably perform the discount sales without overlooking the existence of a discount label.

In the case of the technique disclosed in Patent Document 1, in a case where the discount label or the like cannot be detected by image analysis, a method for ending the process without performing the discount is disclosed. It is considered that this is a process based on the premise that “a product for which a discount label or the like cannot be detected”=“a product to which the discount label or the like is not attached”. However, a case where the discount label is actually provided but cannot be detected due to being hidden by a hand, a blurred image, or the like may occur. In this case, the product may be sold without discount.

In the case of the technique disclosed in Patent Document 2, in a case where the service label cannot be recognized from the service label target product, a notification of the fact is given to an operator. In response to the notification, the operator may visually confirm the existence of the service label. In this case, even in a case where the service label cannot be recognized since the service label is not initially attached, the operator is given the notification, and thus, the operator may perform the visual confirmation according to the notification. As a result, the operator has to perform an unnecessary operation.

The technique disclosed in Patent Document 3 is not a technique of detecting a discount label or the like attached to a product.

An object of the present invention is to provide a technique of recognizing a discount label or the like attached to a product by image analysis and reflecting the result in a checkout process to suppress the inconvenience of selling the product to be discounted without discount, without causing an operator to perform an excessive confirmation operation.

### Solution to Problem

According to an aspect of the present invention, there is provided a settlement system including: an acquisition unit that acquires an image including a product, generated by an imaging unit; an image analysis unit that recognizes the product and a first pattern or a second pattern attached to the product by image analysis; and a registration unit that registers the product without changing a price of the product in a case where the first pattern is recognized, and registers the product by changing the price of the product in a case where the second pattern is recognized.

Further, according to another aspect of the present invention, there is provided a settlement method executed by a computer, the method including: an acquisition step of acquiring an image including a product, generated by an imaging unit, an image analysis step of recognizing the product and a first pattern or a second pattern attached to the product by image analysis; and a registration step of registering the product without changing a price of the product in a case where the first pattern is recognized, and registering the product by changing the price of the product in a case where the second pattern is recognized.

Further, according to still another aspect of the present invention, there is provided a program causing a computer to function as: an acquisition unit that acquires an image including a product, generated by an imaging unit; an image analysis unit that recognizes the product and a first pattern or a second pattern attached to the product by image analysis; and a registration unit that registers the product without changing a price of the product in a case where the first pattern is recognized, and registers the product by changing the price of the product in a case where the second pattern is recognized.

Further, according to still another aspect of the present invention, there is provided a settlement method executed by a computer, the method including: an acquisition step of acquiring an image including a product, generated by an imaging unit, an image analysis step of recognizing the product and additional information attached to the product by image analysis, and determining whether a predetermined part of the product exists in the image; a registration step of registering the recognized product; and a notification step of performing a notification for confirming the presence or absence of the additional information in a case where the additional information cannot be recognized and the predetermined part of the product does not exist in the image.

Further, according to still another aspect of the present invention, there is provided a program causing a computer to function as: an acquisition unit that acquires an image including a product, generated by an imaging unit; an image analysis unit that recognizes the product and additional information attached to the product by image analysis, and determines whether a predetermined part of the product exists in the image; a registration unit that registers the recognized product; and a notification unit that performs a notification for confirming the presence or absence of the additional information in a case where the additional information cannot be recognized and the predetermined part of the product does not exist in the image.

### Advantageous Effects of Invention

According to the present invention, in a technique of recognizing a discount label or the like attached to a product by image analysis and reflecting the result in a checkout process, it is possible to suppress the inconvenience of selling the product to be discounted without discount, without causing an operator to perform an excessive confirmation operation.

### BRIEF DESCRIPTION OF THE DRAWINGS

The above-described object, other objects, features and advantages will be further clarified by the preferred example embodiments described below and the accompanying drawings.

FIG. 1 is a diagram schematically showing an example of a normal sales label M1 according to the present example embodiment.

FIG. 2 is a diagram schematically showing an example of a discount label M2 according to the present example embodiment.

FIG. 3 is a functional block diagram showing an example of a settlement system 10 according to the present example embodiment.

FIG. 4 is a diagram showing an example of a hardware configuration of an apparatus according to the present example embodiment.

FIG. 5 is a diagram schematically showing an example of an imaging system that images a product that is a checkout target.

FIG. 6 is a diagram schematically showing an example of an imaging system that images a product that is a checkout target.

FIG. 7 is a flowchart showing an example of a processing flow of the settlement system 10 according to the present example embodiment.

FIG. 8 is a diagram schematically showing an example of a position to which the discount label M2 or the like is attached, according to the present example embodiment.

FIG. 9 is a flowchart showing an example of a processing flow of the settlement system 10 according to the present example embodiment.

### DESCRIPTION OF EMBODIMENTS

### First Example Embodiment

First, an outline of a settlement system according to the present example embodiment will be described. The settlement system according to the present example embodiment recognizes a discount label or the like attached to a product by image analysis, and reflects the result in a checkout process. The settlement system may be a system that is operated by a store clerk, or may be a system that is operated by a customer.

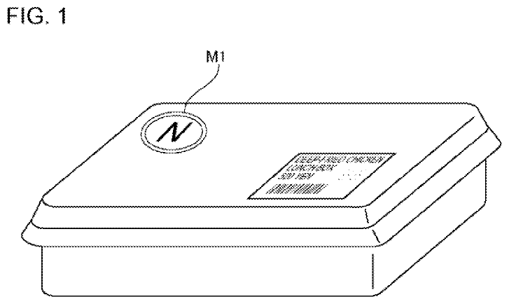

In a checkout practice using the settlement system, as shown in FIG. 1, a label (a normal sales label M1) indicating that a product is not a discount target is attached to the product that is not the discount target. Design, shape, color, or the like of the normal sales label M1 may be appropriately set as necessary.

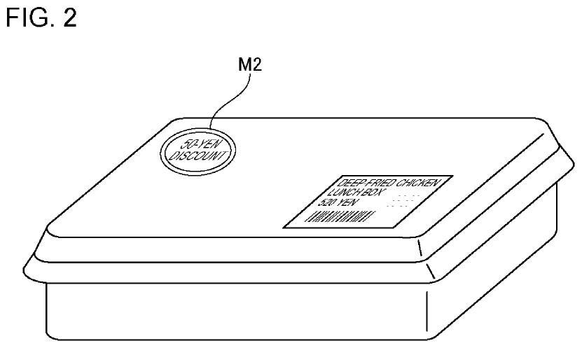

Further, in the checkout practice, as shown in FIG. 2, a label (a discount label M2) indicating that a product is to be discounted is attached to the product to be discounted. Design, shape, color, or the like of the discount label M2 may be appropriately set as necessary. The discount label M2 may include information indicating discount content. In the example shown in the figure, “50 yen discount” is clearly specified as the discount content. The discount content may be other content such as “10 yen discount”, “100 yen discount”, “10% discount”, “20% discount”, or the like.

The “product to be discounted” is also a “product that is not a discounting target” at first, and becomes a “product to be discounted” for some reasons, such as an impending expiration date or an impending best-by date. Thus, the normal sales label M1 is initially attached to the product to be discounted.

In a case where the discount label M2 is attached to a product, it is desirable to perform a process for causing the normal sales label M1 attached to the product to be invisible. The “process for invisibility” is synonymous with “a process for causing the normal sales label M1 so as not to be recognized by image analysis based on pattern matching”. For example, the discount label M2 may be overlapped on the normal sales label M1, the normal sales label M1 may be removed from the product, a part of the normal sales label M1 may be painted with a pen or the like, or other methods may be adopted.

Based on such a premise, the settlement system according to the present example embodiment, after acquiring an image captured by imaging a product, executes a process of recognizing the normal sales label M1 and a process of recognizing the discount label M2 by image analysis. Then, the settlement system according to the present example embodiment executes a process according to the recognition result.

In a case where the normal sales label M1 is recognized, the product is registered as a checkout target without changing its price. In a case where the discount label M2 is recognized, the product is registered as a checkout target by changing the price. In a case where neither the normal sales label M1 nor the discount label M2 can be recognized, a warning may be output.

However, as a situation in which the discount label M2 cannot be recognized, there are “(1) a case where the discount label M2 is actually attached to the product but cannot be recognized due to being hidden by a hand, a blurred image, or the like”, and “(2) a case where the discount label M2 is not initially attached to the product”. In the related art, there has been no method for distinguishing these two cases. Therefore, in a case where the discount label M2 cannot be recognized, one process has been uniformly performed as in the techniques disclosed in Patent Documents 1 and 2. As a result, various inconveniences have occurred (for details, as described in “SOLUTION TO PROBLEM”).

On the other hand, according to the settlement system of the present example embodiment, the above two cases can be distinguished on the basis of the recognition result of the normal sales label M1. Specifically, a case where the normal sales label M1 can be recognized corresponds to the above-mentioned case (2), and a case where the normal sales label M1 cannot be recognized corresponds to the above-mentioned case (1).

As described above, according to the settlement system of the present example embodiment, it is possible to identify in more detail a situation in a case where the discount label M2 cannot be recognized, and to perform an appropriate process according to the identified situation. As a result, it is possible to reduce the inconvenience of selling a product to be discounted without discount or causing an operator to perform an excessive confirmation operation.

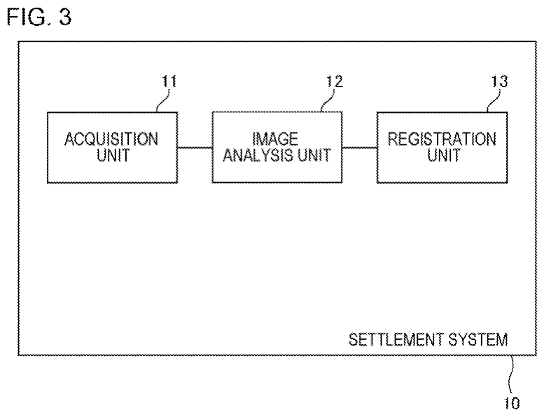

Next, a configuration of the settlement system 10 will be described in detail. FIG. 3 shows an example of a functional block diagram of the settlement system 10. As illustrated, the settlement system 10 includes an acquisition unit 11, an image analysis unit 12, and a registration unit 13.

The settlement system 10 may be realized by a plurality of physically and/or logically separated apparatuses, or may be realized by a physically and/or logically single apparatus. In a case where the settlement system 10 is realized by the plurality of physically and/or logically separated apparatuses, the plurality of apparatuses are configured to be able to communicate with each other in a wired and/or wireless manner. For example, the acquisition unit 11 and the registration unit 13 may be realized by a first apparatus, and the image analysis unit 12 may be realized by a second apparatus that is physically and/or logically separated from the first apparatus.

These functional units included in the settlement system 10 may be realized by any combination of hardware and software centering on a central processing unit (CPU), a memory, a program loaded in the memory, and a storage unit such as a hard disk that stores the program (and is able to store a program stored in advance at a shipping stage of an apparatus, and a program downloaded from a storage medium such as a CD (compact disc), a server on the Internet, or the like), and a network connection interface of any computer. It will be understood by those skilled in the art that there are various modified examples of methods and apparatuses for realizing the functional units.

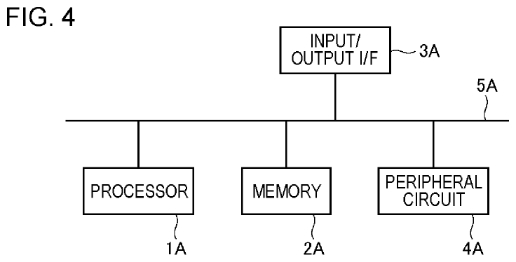

FIG. 4 is a block diagram showing a hardware configuration of the settlement system 10. As shown in FIG. 4, the settlement system 10 includes a processor 1A, a memory 2A, an input/output interface 3A, a peripheral circuit 4A, and a bus 5A. The peripheral circuit 4A includes various modules. A configuration in which the peripheral circuit 4A is not provided may also be used. In a case where the settlement system 10 is realized by a plurality of physically and/or logically separated apparatuses, each apparatus may have the hardware configuration.

The bus 5A is a data transmission path through which the processor 1A, the memory 2A, the peripheral circuit 4A, and the input/output interface 3A mutually exchange data. The processor 1A is an arithmetic processing unit such as a central processing unit (CPU) or a graphics processing unit (GPU). The memory 2A is a memory such as a random access memory (RAM) or a read only memory (ROM). The input/output interface 3A includes an interface for acquiring information from an input device (for example, a keyboard, a mouse, a microphone, or the like), an external device, an external server, an external sensor, or the like, and an interface for outputting information to an output device (for example, a display, a speaker, a printer, a mailer, or the like), an external device, an external server, or the like. The processor 1A may issue a command to each module, and perform a calculation on the basis of a calculation result of each module.

Returning to FIG. 3, a functional configuration of each functional unit will be described. The acquisition unit 11 acquires an image including a product, generated by an image unit (camera).

For example, an imaging system including a base on which a product that is a checkout target is placed and a camera that takes an image of a placing surface of the base may be prepared. Then, the acquisition unit 11 may acquire the image (a motion picture or a still image) generated by the camera.

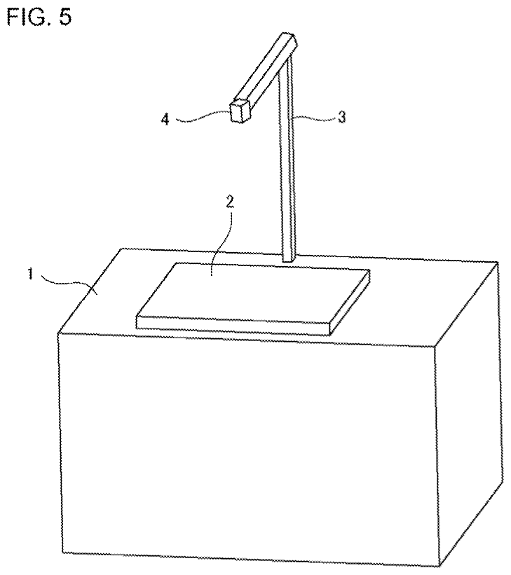

The imaging system may include a base 1, a member 2, a support 3, and a camera 4, as shown in FIG. 5, for example. The member 2 is placed on an upper surface of the base 1, and forms a part of the base 1. An exposed surface of the member 2 serves as a surface on which a product is placed. That is, a customer or a store clerk places the product that is a checkout target on the exposed surface of the member 2. The member 2 may be a display, or may be a different type of member.

The camera 4 is attached to the support 3, and images the exposed surface of the member 2 from above. The image (for example, a motion picture) generated by the camera 4 is transmitted to the settlement system 10 (not shown) by wired and/or wireless communication. The acquisition unit 11 acquires the image.

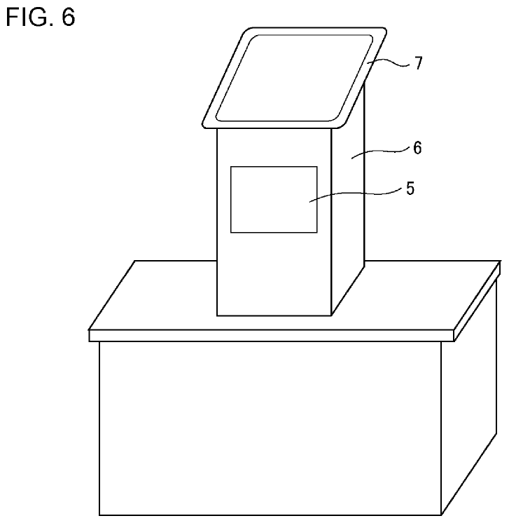

Further, an imaging system in which an image of each product is generated by holding each product in front of the camera may be prepared. The imaging system includes a reading window 5, a housing 6, and a display 7, as shown in FIG. 6, for example. A camera (not shown) is installed inside the housing 6. The reading window 5 is configured to transmit light. The camera takes an image of the product held over the reading window 5 through the reading window 5. The image (for example, a motion picture) generated by the camera is transmitted to the settlement system 10 (not shown) by wired and/or wireless communication. The acquisition unit 11 acquires the image.

Returning to FIG. 3, the image analysis unit 12 recognizes a product and a first pattern or a second pattern attached to the product by image analysis. The image analysis unit 12 may recognize the product, the first pattern, and the second pattern using a pattern matching technique or the like.

“Product Recognition Method”

For example, the image analysis unit 12 detects an object included in an image using a technique such as binarization of the image and extraction of a contour line (object detection). Thereafter, the analysis unit 12 collates an appearance feature (a feature of a region where the object exists in the image) that appears in an image of the detected object and an appearance feature (reference information) of each of a plurality of products registered in advance to determine which product the object is (product recognition). For example, the analysis unit 12 may determine a product having the highest appearance similarity degree to the object, or a product having the highest appearance similarity degree to the object and a similarity degree equal to or greater than a reference value. Examples of the appearance feature of the product include a color, a surface irregularity, and a shape, but are not limited thereto.

In addition, after detecting the object, the image analysis unit 12 may detect a code (for example, a barcode, a two-dimensional code) from the region where the object exists in the image using pattern matching or the like. Then, the image analysis unit 12 may acquire information for identifying a product indicated by the code by analyzing the code and converting a code pattern into information (product recognition).

In this way, the image analysis unit 12 recognizes a product using an image other than the first pattern and the second pattern. That is, the image analysis unit 12 does not use the first pattern and the second pattern for product recognition. The first pattern and the second pattern are not information about the product itself, and thus, are not used for product recognition. Thus, it is possible to improve the accuracy of product recognition.

“First Pattern Recognition Method”

After detecting the object from the image, the image analysis unit 12 detects the first pattern from the region where the object exists in the image. That is, the image analysis unit 12 detects a region showing a feature of the first pattern from the region where the object exists in the image using a pattern matching technique or the like (first pattern recognition). The first pattern shows a part (characteristic part) or all of appearance features of the normal sales label M1.

“Second Pattern Recognition Method”

After detecting the object from the image, the image analysis unit 12 detects the second pattern from the region where the object exists in the image. That is, the image analysis unit 12 detects a region showing a feature of the second pattern from the region where the object exists in the image using a pattern matching technique or the like (second pattern recognition). The second pattern shows a part (characteristic part) or all of appearance features of the discount label M2.

The image analysis unit 12 may further recognize additional information (discount content) added to the discount label M2.

For example, in a case where the discount labels M2 having different designs are prepared for different discount content, the image analysis unit 12 may recognize the discount content on the basis of the type of the detected discount label M2.

In addition, in a case where the discount labels M2 having the same design are prepared for different discount content, each specifying discount content clearly different in characters, such as “10 yen discount”, “50 yen discount”, “100 yen discount”, “10% discount”, “20% discount”, or the like, the image analysis unit 12 may recognize the discount content by performing a character recognition process for a region where the discount label M2 exists in the image.

The registration unit 13 registers a product recognized by the image analysis unit 12 as a checkout target. That is, the registration unit 13 acquires product information (product name, price, or the like) of the product recognized by the image analysis unit 12 from a product master, and registers the result as a checkout target.

Note that the registration unit 13 changes the content of the registration process for the product according to the recognition result of the first pattern and the second pattern by the image analysis unit 12.

In a case where the first pattern is recognized, the registration unit 13 does not change a price of the product (using the price acquired from the product master as a selling price), and registers the product as a checkout target.

In a case where the second pattern is recognized, the registration unit 13 changes the price of the product (using the price obtained by changing the price acquired from the product master as a selling price), and registers the product as a checkout target. In this case, the registration unit 13 changes the price acquired from the product master on the basis of the discount content recognized by the image analysis unit 12. That is, in a case where the discount content recognized by the image analysis unit 12 is “oo yen discount”, the registration unit 13 sets a price obtained by subtracting “oo yen” from the price acquired from the product master as a selling price. In a case where the discount content recognized by the image analysis unit 12 is “oo % discount”, the registration unit 13 sets a price obtained by discounting oo % of the price acquired from the product master as a selling price.

Further, in a case where both the first pattern and the second pattern are recognized, the registration unit 13 may perform the same process as in a case where the [0] second pattern is recognized. That is, the registration unit 13 changes the price of the product (using the price obtained by changing the price acquired from the product master as a selling price), and registers the product as a checkout target.

Note that in a case where neither the first pattern nor the second pattern is recognized, the registration unit 13 may not register the product as a checkout target. Then, the registration unit 13 may output a message such as “Neither the normal sales label M1 nor the discount label M2 can be recognized in “product oo (a product name of the product recognized by the image analysis unit 12. Please, image the product so that these labels can be seen”.

In addition, in a case where neither the first pattern nor the second pattern are recognized, the registration unit 13 may not change the price of the product (using the price acquired from the product master as a selling price), may register the product as a checkout target, and may execute the following exception process.

In the exception process, first, the registration unit 13 outputs a message such as “Is the discount label M2 attached to the product oo (the product name of the product recognized by the image analysis unit 12)?” (display on a display, voice output, or the like), and may accept a user input of “not attached” or “attached” as a response thereto. Then, in a case where the user input of “not attached” is accepted, the exception process may be ended as it is. On the other hand, in a case where the user input of “attached” is accepted, a user input of specifying the discount content (10 yen discount, 50 yen discount, or the like) may be further accepted. Then, the price of the registered product may be changed on the basis of the specified discount content, and then, the exception process may be ended.

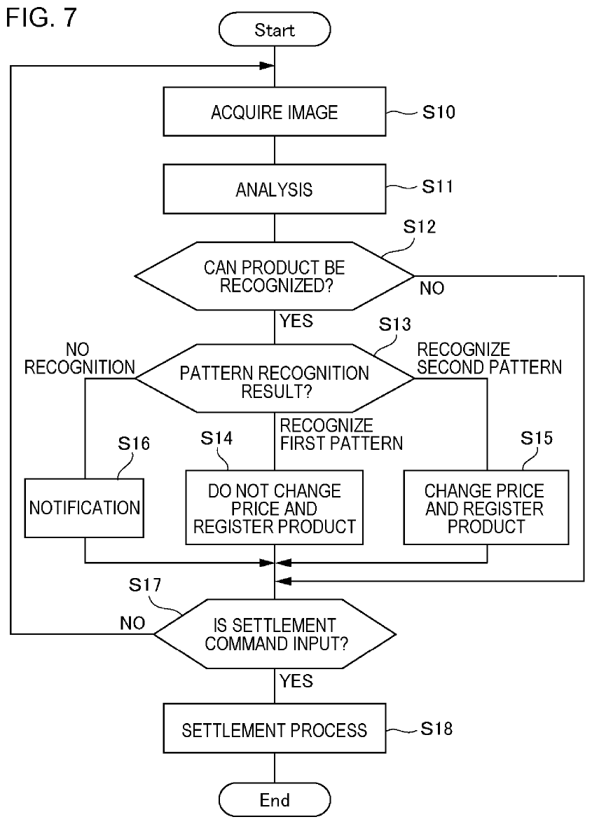

Next, an example of a processing flow of the settlement system 10 will be described using the flowchart of FIG. 7.

An operator (a store clerk or a customer) of the settlement system 10 performs an operation of imaging a product that is a checkout target. For example, an operation of placing the product that is the checkout target on the member 2 shown in FIG. 5 may be performed, or an operation of holding the product that is the checkout target over the reading window 5 shown in FIG. 6 may be performed. As a result of the operation, the product that is the checkout target is imaged by the camera.

The acquisition unit 11 acquires the image generated by the camera (S10). Then, the image analysis unit 12 analyzes the image, and performs a process of recognizing the product, a process of recognizing the first pattern, and a process of recognizing the second pattern (S11). The first pattern is a pattern showing an appearance feature of the normal sales label M1, and the second pattern is a pattern showing an appearance feature of the discount label M2. In a case where the second pattern is recognized, the image analysis unit 12 may further recognize additional information (discount content) added to the discount label M2.

As a result of the image analysis in S11, in a case where the product can be recognized (“Yes” in S12) and the first pattern can be recognized (“recognize the first pattern” in S13), the registration unit 13 does not change the price of the product (using the price acquired from the product master as a selling price), and registers the product as a checkout target (S14).

As a result of the image analysis in S11, in a case where the product can be recognized (“Yes” in S12) and the second pattern can be recognized (“recognize the second pattern” in S13), the registration unit 13 changes the price of the product (using the price obtained by changing the price acquired from the product master as a selling price), and registers the product as a checkout target.

In this case, the registration unit 13 changes the price acquired from the product master on the basis of the discount content recognized by the image analysis unit 12. That is, in a case where the discount content recognized by the image analysis unit 12 is “oo yen discount”, the registration unit 13 sets a price obtained by subtracting “oo yen” from the price acquired from the product master as a selling price. In a case where the discount content recognized by the image analysis unit 12 is “oo % discount”, the registration unit 13 sets a price obtained by discounting oo % of the price acquired from the product master as a selling price.

As a result of the image analysis in S11, in a case where the product can be recognized (“Yes” in S12) but neither the first pattern nor the second pattern can be recognized (“No recognition” in S13), the registration unit 13 does not register the product as a checkout target. Then, the settlement system 10 may output a message such as “Neither the normal sales label M1 nor the discount label M2 can be recognized in the “product oo (product name of the product recognized by the image analysis unit 12). Please, image the product so that these labels can be seen” (S16).

Note that, as a modification example of S16, the registration unit 13 may not change the price of the product (using the price acquired from the product master as a selling price), may register the product as a checkout target, and may execute the above-described exception process.

In a case where a plurality of products are recognized from the image, it is possible to execute the processes of S13 to S16 for each of the recognized plurality of products.

As a result of the image analysis in S11, in a case where the product cannot be recognized (“No” in S12), and in a case where there is no command input to start settlement (“No” in S17), the procedure returns to S10, and the same processes are repeated. Note that, assuming that the configuration of FIG. 5 is used, the image analysis unit 12 may distinguish an object newly placed on the member 2 and an object continuously placed on the member 2, for example, on the basis of a temporal change of the image. Then, in a case where a new object is detected, the registration unit 13 registers the new product as a checkout target on the basis of the recognition result for the object.

In a case where there is a command input to start the settlement (“Yes” in S17), the settlement system 10 executes a settlement process (S18). For example, the settlement system 10 may accept an input of cash as payment of a total payment amount computed on the basis of the products registered so far, and may output change or a receipt as necessary. In addition, the settlement system 10 may accept an input of a credit card, may communicate with a system of a credit company, and may perform a payment process. The settlement system 10 may also transmit information for the settlement process (information indicating registered products, total payment amount, or the like) to another settlement apparatus.

According to the settlement system 10 of the present example embodiment described above, in a case where the discount label M2 cannot be recognized, it is possible to distinguish whether the case is “(1) a case where the discount label M2 is actually attached to the product but cannot be recognized due to being hidden by a hand, a blurred image, or the like”, or “(2) a case where the discount label M2 is not initially attached to the product”. Then, an appropriate process can be performed according to the distinguished situation. Therefore, it is possible to reduce inconvenience that may occur in uniformly performing one process in a case where the discount label M2 cannot be recognized without distinguishing the two situations. That is, it is possible to reduce the inconvenience of selling the discount target product without discount or causing an operator to perform an excessive confirmation operation.

### Second Example Embodiment

The settlement system 10 of the present example embodiment is different from that of the first example embodiment in details of the process of recognizing the first pattern and the second pattern. Other configurations are similar to those of the first example embodiment.

An example of the hardware configuration of the settlement system 10 of the present example embodiment is the same as that of the first example embodiment.

A functional block diagram of the settlement system 10 of the present example embodiment is shown in FIG. 3 as in the first example embodiment. The configuration of the acquisition unit 11 is similar to that of the first example embodiment. The configurations of the image analysis unit 12 and the registration unit 13 will be described below. Points different from the first example embodiment will be described, and description of points common to the first example embodiment will not be repeated.

First, in a checkout practice using the settlement system 10 of the present example embodiment, in addition to the premise described in the first example embodiment, there is a premise that “a normal sales label M1 and a discount label M2 are attached to a predetermined part of the product”.

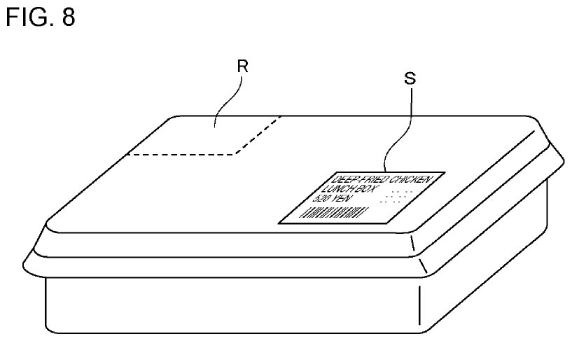

For example, in the case of the product shown in FIG. 8, it may be decided that the normal sales label M1 and the discount label M2 are attached to a part R. In this case, the part R is defined as, for example, “a surface to which a label S including a product name, a barcode, or the like is attached, which is within a predetermined distance from the diagonal of a corner of the surface closest to the label S”. The position of the part R and its definition may be appropriately set as necessary.

Then, the image analysis unit 12 detects a predetermined part of a product, that is, a part defined as a position to which the normal sales label M1 and the discount label M2 are attached, in a region where the product is present in an image (a display region of the product). The image analysis unit 12 holds in advance information that defines the part. Then, the image analysis unit 12 detects the predetermined part of the product on the basis of the information that defines the part. The information that defines the part may be different for each product. The image analysis unit 12 may first recognize the product, and then, may acquire the information that defines the predetermined part of the product on the basis of the recognition result.

For example, in a case where the part R of the product shown in FIG. 8 is a predetermined part to which the discount label M2 is attached, information that defines the part may be “a surface to which a label S including a product name, a barcode, or the like is attached, which is within a predetermined distance from the diagonal of a corner of the surface closest to the label S”.

After detecting the predetermined part of the product in the image, the image analysis unit 12 executes a process of recognizing the first pattern and a process of recognizing the second pattern for the display region of the predetermined part of the product in the image, and recognizes at least one of the first pattern or the second pattern. In this way, it is possible to reduce computer load in the recognition process.

The registration unit 13 issues a notification to an operator (clerk or customer), in a case where the predetermined part of the product is not detected. In a case where the predetermined part of the product cannot be detected, it is not possible to recognize the normal sales label M1 and the discount label M2. By notifying the operator of such a situation, it is possible to suppress the inconvenience of selling a discount target product without discount.

For example, in a case where the product is recognized but the predetermined part of the product is not detected, the registration unit 13 may not register the product as a checkout target. Then, the registration unit 13 may output a message such as “The existence of the part to which the normal sales label M1 and the discount label M2 are attached cannot be confirmed in the product oo (the product name of the product recognized by the image analysis unit 12) in the image. Please, image the product so that the part can be seen.”.

In addition, in a case where the product is recognized but the predetermined part of the product is not detected, the registration unit 13 may not change the price of the product (using the price acquired from the product master as a selling price), may register the product as a checkout target, and may execute the following exception process.

In the exception process, first, the registration unit 13 may output (display, voice output, or the like) a message such as “Is the discount label M2 attached to the product oo (the product name of the product recognized by the image analysis unit 12)?”, and may accept an input of “not attached” or “attached” as an answer. Then, in a case where the input of “not attached” is accepted, the exception process may be ended as it is. On the other hand, in a case where the input of “attached” is received, an input of specifying the discount content may be further accepted. Then, the price of the registered product may be changed on the basis of the specified discount content, and then, the exception process may be ended.

According to the settlement system 10 of the present example embodiment described above, it is possible to achieve the same advantageous effects as those of the first example embodiment. Further, according to the settlement system 10 of the present example embodiment, it is possible to reduce the computer load in the process of recognizing the normal sales label M1 or the discount label M2, and additionally, it is possible to more effectively reduce the inconvenience of selling the discount target product without discount by performing two steps of “detecting the part to which the normal sales label M1 or the discount label M2 is attached” and “recognizing the normal sales label M1 and the discount label M2”.

### Third Example Embodiment

First, a premise in a checkout practice using the settlement system of the present example embodiment is the same as that of the second example embodiment, except that the normal sales label M1 is not attached to a product. That is, a label (discount label M2) indicating that a product is a discount target is attached to a discount target product, as shown in FIG. 2. Further, the discount label M2 is attached to a predetermined part of the product.

Based on such a premise, the settlement system 10 of the present example embodiment realizes the same advantageous effects as those of the first and second example embodiments.

An example of a hardware configuration of the settlement system 10 of the present example embodiment is similar to those of the first and second example embodiments.

A functional block diagram of the settlement system 10 of the present example embodiment is shown in FIG. 3 as in the first and second example embodiments. The configuration of the acquisition unit 11 is similar to that of the first and second example embodiments. The configurations of the image analysis unit 12 and the registration unit 13 will be described below. Note that points different from the first and second example embodiments will be described, and description of points common to the first and second example embodiments will not be repeated.

The image analysis unit 12 analyzes an image to recognize a product. Further, the image analysis unit 12 analyzes the image to recognize additional information added to a second pattern. The second pattern shows a part (characteristic part) or all of appearance features of the discount label M2. The additional information indicates discount content. Since the details of the process have been described in the first example embodiment, description thereof will not be repeated.

Further, the image analysis unit 12 determines whether or not there is a predetermined part of the product, that is, a part defined as a position to which the discount label M2 is attached, in a region where the product is present in the image (display region of the product). Then, in a case where there is the predetermined part of the product in the image, the image analysis unit 12 executes a process of recognizing the second pattern for the display region of the predetermined part of the product in the image to recognize the second pattern. Since the details of the process have been described in the second example embodiment, description thereof will not be repeated.

In a case where at least one of the recognition of the additional information or the determination that the predetermined part of the product exists in the image is performed, the registration unit 13 registers the recognized product as a checkout target.

In a case where the additional information is recognized, the registration unit 13 changes a price of the product (using a price obtained by changing the price acquired from the product master as a selling price), and registers the product as a checkout target. In this case, the registration unit 13 changes the price acquired from the product master on the basis of the discount content (content of the additional information) recognized by the image analysis unit 12. That is, in a case where the discount content recognized by the image analysis unit 12 is “oo yen discount”, the registration unit 13 sets a price obtained by subtracting “oo yen” from the price acquired from the product master as a selling price. In a case where the discount content recognized by the image analysis unit 12 is “oo % discount”, the registration unit 13 sets a price obtained by discounting oo % of the price acquired from the product master as a selling price.

On the other hand, in a case where the additional information is not recognized but it is determined that the predetermined part of the product exists in the image, the registration unit 13 does not change the price of the product (using the price acquired from the product master as a selling price), and registers the product as a checkout target.

In a case where the additional information cannot be recognized and it is not determined that the predetermined part of the product exists in the image, the registration unit 13 may not register the recognized product as a checkout target. Then, the registration unit 13 may output a message such as “The existence of the part to which the sales discount label M2 is attached cannot be confirmed in the “product oo (the product name of the product recognized by the image analysis unit 12). Please, image the product so that the part can be seen.”.

In addition, in a case where the additional information cannot be recognized and it is not determined that the predetermined part of the product exists in the image, the registration unit 13 may not change the price of the recognized product (using the price acquired from the product master as a selling price), may register the product as a checkout target, and may execute the following exception process.

In the exception process, first, the registration unit 13 may output (display, voice output, or the like) a message such as “Is the discount label M2 attached to the product oo (the product name of the product recognized by the image analysis unit 12)?”, and may accept an input of “not attached” or “attached” as an answer. Then, in a case where the input of “not attached” is accepted, the exception process may be ended as it is. On the other hand, in a case where the input of “attached” is received, an input of specifying the discount content may be further accepted. Then, the price of the registered product may be changed on the basis of the specified discount content, and then, the exception process may be ended.

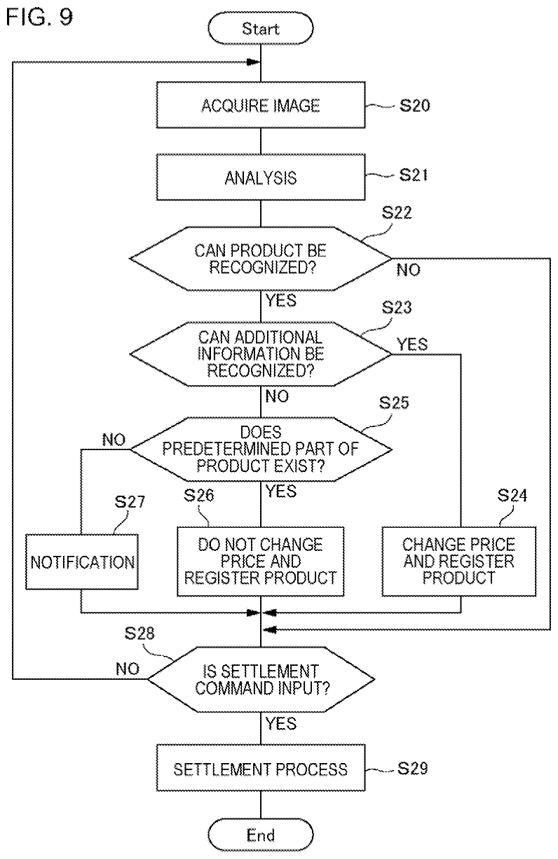

Next, an example of a processing flow of the settlement system 10 will be described with reference to the flowchart of FIG. 9.

An operator (a store clerk or a customer) of the settlement system 10 performs an operation of imaging a product that is a checkout target. For example, an operation of placing the product that is the checkout target on the member 2 shown in FIG. 5 may be performed, or an operation of holding the product that is the checkout target over the reading window 5 shown in FIG. 6 may be performed. As a result of the operation, the product that is the checkout target is imaged by the camera.

The acquisition unit 11 acquires an image generated by the camera (S20). Then, the image analysis unit 12 performs a process of analyzing the image to recognize the product, a process of detecting a predetermined part of the product, and a process of recognizing a second pattern (S21). The second pattern is a pattern indicating an appearance feature of the discount label M2. The predetermined part of the product is a part determined as a position to which the discount label M2 is attached. In a case where the second pattern is recognized, the image analysis unit 12 may further recognize additional information (discount content) added to the discount label M2.

As a result of the image analysis in S21, in a case where the product can be recognized (“Yes” in S22) and the additional information can be recognized (“Yes” in S23), the registration unit 13 changes a price of the product (using the price obtained by changing the price acquired from the product master as a selling price), and registers the recognized product as a checkout target (S24).

In this case, the registration unit 13 changes the price acquired from the product master on the basis of the discount content recognized by the image analysis unit 12. That is, in a case where the discount content recognized by the image analysis unit 12 is “oo yen discount”, the registration unit 13 sets a price obtained by subtracting “oo yen” from the price acquired from the product master as a selling price. In a case where the discount content recognized by the image analysis unit 12 is “oo % discount”, the registration unit 13 sets a price obtained by discounting oo % of the price acquired from the product master as a selling price.

As a result of the image analysis in S21, in a case where the product can be recognized (“Yes” in S22) but the additional information cannot be recognized (“No” in S23), and it is determined that the predetermined part of the product exists in the image (“Yes” in S25), the registration unit 13 does not change the price of the product (using the price acquired from the product master as a selling price), and registers the recognized product as a checkout target (S26).

As a result of the image analysis in S21, the product can be recognized (“Yes” in S22) but the additional information cannot be recognized (“No” in S23), and it is not determined that a predetermined part of the product exists in the image (“No” in S25), the registration unit 13 may not register the product as a checkout target. Then, the settlement system 10 may output a message such as “The existence of the part to which the discount label M2 is attached cannot be confirmed in the product oo (the product name of the product recognized by the image analysis unit 12) in the image. Please, image the product so that the part can be seen.” (S27). In addition, the registration unit 13 may not change the price of the product (using the price acquired from the product master as the selling price), may register the product as a checkout target, and may execute the above-described exception process.

In a case where a plurality of products are recognized from the image, the processes of S23 to S27 may be executed for each of the recognized plurality of products.

As a result of the image analysis in S21, in a case where the product cannot be recognized (“No” in S22) and there is no command input for starting the settlement (“No” in S28), the procedure returns to S20, and then, the same processes are repeated. Note that, assuming that the configuration of FIG. 5 is used, the image analysis unit 12 may distinguish an object newly placed on the member 2 and an object continuously placed on the member 2, for example, on the basis of a temporal change of the image. Then, in a case where a new object is detected, the registration unit 13 registers the new product as a checkout target on the basis of the recognition result for the object.

In a case where there is a command input for starting the settlement (“Yes” in S28), the settlement system 10 executes a settlement process (S29). For example, the settlement system 10 may accept an input of cash as payment of a total payment amount computed on the basis of the products registered so far, and may output change or a receipt as necessary. In addition, the settlement system 10 may accept an input of a credit card, may communicate with a system of a credit company, and may perform a payment process. The settlement system 10 may also transmit information for the settlement process (information indicating registered products, total payment amount, or the like) to another settlement apparatus.

According to the settlement system 10 of the present example embodiment described above, it is possible to realize the same advantageous effects as those of the first and second example embodiments. Further, according to the settlement system 10 of the present example embodiment, it is not necessary to attach the normal sales label M1 to a product. Therefore, it is possible to reduce the labor of attaching the normal sales label M1 to the product.

Hereinafter, examples of reference modes will be additionally described.

1. A settlement system including:

an acquisition unit that acquires an image including a product, generated by an imaging unit;

an image analysis unit that recognizes the product and a first pattern or a second pattern attached to the product by image analysis; and

a registration unit that registers the product without changing a price of the product in a case where the first pattern is recognized, and registers the product by changing the price of the product in a case where the second pattern is recognized.

2. The settlement system according to 1,

in which the image analysis unit detects a predetermined part of the product in a display region of the product, analyzes a display region of the part, and recognizes at least one of the first pattern or the second pattern.

3. The settlement system according to 2,

in which in a case where the predetermined part of the product is not detected, the registration unit issues a notification to an operator.

4. The settlement system according to any one of 1 to 3,

in which the image analysis unit recognizes the product by an image other than the first pattern and the second pattern.

5. A settlement system including:

an acquisition unit that acquires an image including a product, captured by an imaging unit;

an image analysis unit that recognizes the product and additional information attached to the product by image analysis, and determines whether a predetermined part of the product exists in the image; and

a registration unit that issues a notification in a case where the additional information cannot be recognized and the predetermined part of the product does not exist in the image.

6. The settlement system according to 5,

in which the registration unit registers, in a case where at least one of the recognition of the additional information or the determination that the predetermined part of the product exists in the image is performed, the recognized product.

7. A settlement method executed by a computer, the method including:

an acquisition step of acquiring an image including a product, generated by an imaging unit,

an image analysis step of recognizing the product and a first pattern or a second pattern attached to the product by image analysis; and

a registration step of registering the product without changing a price of the product in a case where the first pattern is recognized, and registering the product by changing the price of the product in a case where the second pattern is recognized.

8. A program causing a computer to function as:

an acquisition unit that acquires an image including a product, generated by an imaging unit;

an image analysis unit that recognizes the product and a first pattern or a second pattern attached to the product by image analysis; and

a registration unit that registers the product without changing a price of the product in a case where the first pattern is recognized, and registers the product by changing the price of the product in a case where the second pattern is recognized.

9. A settlement method executed by a computer, the method including:

an acquisition step of acquiring an image including a product, generated by an imaging unit,

an image analysis step of recognizing the product and additional information attached to the product by image analysis, and determining whether a predetermined part of the product exists in the image;

a registration step of registering the recognized product; and

a notification step of performing a notification for confirming the presence or absence of the additional information in a case where the additional information cannot be recognized and the predetermined part of the product does not exist in the image.

10. A program causing a computer to function as:

an acquisition unit that acquires an image including a product, generated by an imaging unit;

an image analysis unit that recognizes the product and additional information attached to the product by image analysis, and determines whether a predetermined part of the product exists in the image;

a registration unit that registers the recognized product; and

a notification unit that performs a notification for confirming the presence or absence of the additional information in a case where the additional information cannot be recognized and the predetermined part of the product does not exist in the image.

This application claims the priority on the basis of Japanese Patent Application No. 2018-050585 filed on Mar. 19, 2018, the entirety of which is incorporated herein by reference.

What is claimed is:

1. A settlement system comprising:
at least one memory configured to store one or more instructions; and
at least one processor configured to execute the one or more instructions to:
acquire an image including a product a product;
recognize the product and a first pattern or a second pattern attached to the product by image analysis; and
register the product without changing a price of the product in a case where the first pattern is recognized, and register the product by changing the price of the product in a case where the second pattern is recognized.

2. The settlement system according to claim 1,
wherein the processor is further configured to execute the one or more instructions to detect a predetermined part of the product in a display region of the product, analyze a display region of the part, and recognize at least one of the first pattern or the second pattern.

3. The settlement system according to claim 2,
wherein the processor is further configured to execute the one or more instructions to issue a notification to an operator in a case where the predetermined part of the product is not detected.

4. The settlement system according to claim 1,
wherein the processor is further configured to execute the one or more instructions to recognize the product by an image other than the first pattern and the second pattern.

5. A settlement system comprising:
at least one memory configured to store one or more instructions; and
at least one processor configured to execute the one or more instructions to:
acquire an image including a product;
recognize the product and additional information attached to the product by image analysis, and determine whether a predetermined part of the product exists in the image; and
issue a notification in a case where the additional information cannot be recognized and the predetermined part of the product does not exist in the image.

6. The settlement system according to claim 5,
wherein the processor is further configured to execute the one or more instructions to register, in a case where at least one of the recognition of the additional information or the determination that the predetermined part of the product exists in the image is performed, the recognized product.

7. A settlement method executed by a computer, the method comprising:
acquiring an image including a product,
recognizing the product and a first pattern or a second pattern attached to the product by image analysis; and
registering the product without changing a price of the product in a case where the first pattern is recognized, and registering the product by changing the price of the product in a case where the second pattern is recognized.

8. A non-transitory storage medium storing a program causing a computer to:
acquire an image including a product;
recognize the product and a first pattern or a second pattern attached to the product by image analysis; and
register the product without changing a price of the product in a case where the first pattern is recognized, and register the product by changing the price of the product in a case where the second pattern is recognized.

9. A settlement method executed by a computer, the method comprising:
acquiring an image including a product,
recognizing the product and additional information attached to the product by image analysis, and determining whether a predetermined part of the product exists in the image;
registering the recognized product; and
performing a notification for confirming the presence or absence of the additional information in a case where the additional information cannot be recognized and the predetermined part of the product does not exist in the image.

10. A non-transitory storage medium storing a program causing a computer to:
acquire an image including a product;
recognize the product and additional information attached to the product by image analysis, and determine whether a predetermined part of the product exists in the image;
register the recognized product; and
perform a notification for confirming the presence or absence of the additional information in a case where the additional information cannot be recognized and the predetermined part of the product does not exist in the image.
